(19) United States
(12) Patent Application Publication
(10) Pub. No.: US 2007/0073713 A1
(43) Pub. Date: Mar. 29, 2007

(54) Term search and link creation from a graphical user interface associated with presentation code

(75) Inventor: Pavithran D. Thomas, Orlando, FL (US)

Correspondence Address: Adam E. Crall-Carlton Fields, P.A., P.O. Box 3239, Tampa, FL, 33601-3239, US

(73) Assignee: Teleios, Inc.

(21) Appl. No.: 11/238,378

(22) Filed: Sep. 29, 2005

(51) Int. Cl. G06F 17/30

(52) U.S. Cl. 707/10

(57) ABSTRACT

Various computer systems, methods, and associated computer software are provided for enabling a user to conveniently initiate a search of term(s) displayed by presentation code in a graphical user interface (GUI) and to create a link between the term(s) and resources identified in the search. One embodiment is a method for performing a computer-based search within a presentation window of a graphical user interface, the method comprising: selecting an object displayed by presentation code in a graphical user interface, the selected object corresponding to at least one term to be searched; initiating a search of the at least one term; displaying the results of the search; selecting a resource from the results to be linked to the selected object; and linking the selected object displayed by the presentation code to the selected resource.

### BACKGROUND

Many existing computer systems, methods, and computer software enable computer end users to search a database or index containing various resources or documents based on keywords or search terms. In these systems, the computer end user specifies the keyword(s) or search term(s) for the search, and a computer program searches the database to determine whether there are any relevant documents or resources corresponding to the keyword(s) or terms(s). The search facility may involve a local database, although various types of search engines (in combination with, for example, a browser) enable the computer end user to search the collective resources of the Web for relevant documents associated with the keyword(s) or search term(s). Typically, the results of the search are displayed to the computer end user, via a browser, as a list of hypertext links to the relevant documents or resources. For example, the search results may be presented in a browser window and in a format suitable for enabling the computer end user to, for example, select desirable links, browse the search results, view the relevant documents or resources, and perform additional searches.

Currently, there are various user interface mechanisms by which a computer end user may initiate the search and/or specify the keyword(s) and search term(s). For example, various search portals enable computer end users to access a web page via a browser application, and input the keyword(s) or search term(s) into a textbox displayed on the web page. The results of the search are displayed to the end user via a browser, a plug-in, or other program or application.

Another search triggering mechanism comprises a user interface search toolbar, which typically appears as a textbox adjacent a menubar (or similar GUI tool) associated with a computer application, such as a browser. The search toolbar enables the user to easily input the keyword(s) or term(s) without having to access a separate application or web page. For instance, a user may encounter a particular topic of interest while reading an article on a web page, and desire to perform a search of the topic. Instead of navigating to a search portal or opening another browser window to initiate the search, the search toolbar enables the user to insert the search terms and initiate the search from the same window as the web page.

Some computer applications provide functionality which enables the user to trigger a search directly from the text displayed in the application. For example, an end user may desire to perform a search of a particular term displayed via the application. While receding an article in a web page, the user may encounter, for example, the terms “Baroque music” and desire to perform a quick search or database look-up of the terms. In such systems, the end user may select the displayed text (in this case, “Baroque music”) directly from the application (e.g., via mouse or other navigational commands). Then, the user may initiate the search of the selected text by performing a mouse right-click, or other, command. The mouse right-click command opens a menu window from which the end user may select a “search” command. When the end user triggers the search, the selected terms are searched using a search engine. The results of the search are typically displayed in a separate browsing window, in which the end user may interact with the results or perform additional searches.

Some word processing applications offer a dictionary look-up feature which enables an end user to select contiguous words displayed in the document and search for the definition of, or synonyms for, the selected words in a local dictionary database. The results of the dictionary look-up are provided in a search pane. The end user may interface with the search pane by selecting certain words and synonyms and performing additional searches. The search pane also includes a functionality which enables the end user to select a replacement word or synonym and initiate a command to insert the replacement word for the original selected term in the document.

Despite the existence of various user interface mechanisms for initiating a search, there is a need in the art for improved computer systems, methods, and computer software for enabling users to conveniently initiate searches in a graphical user interface (GUI) environment.

### SUMMARY

Various computer systems, methods, and associated computer software are provided for enabling a user to conveniently initiate a search of term(s) displayed by presentation code in a graphical user interface (GUI) and to create a link between the term(s) and resource(s) identified in the search. One embodiment is a computer system comprising: a graphical user interface; presentation code for displaying information via the graphical user interface; a search engine; and term-search-and-link-creation (TSLC) code comprising logic configured to enable a user to select a term displayed by the presentation code, initiate a search of the term via the search engine, and create a hypertext link between the term and a resource from results of the search.

Another embodiment of a computer system comprises: presentation code for displaying information via a graphical user interface; and a term-search-and-link-creation (TSLC) module for interfacing with the presentation code and a search engine, the TSLC module comprising: logic configured to receive a user term selection of at least one term displayed by the presentation code; logic configured to initiate a search with the search engine based on the at least one displayed term; logic configured to receive a user resource selection of at least one resource from results of the search; and logic configured to generate a link between the at least one displayed term and the at least one resource.

Yet another embodiment is a method for performing a computer-based search within a presentation window of a graphical user interface, the method comprising: selecting an object displayed by presentation code in a graphical user interface, the selected object corresponding to at least one term to be searched; initiating a search of the at least one term; displaying the results of the search; selecting a resource from the results to be linked to the selected object; and linking the selected object displayed by the presentation code to the selected resource.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram illustrating one of a number of possible embodiments of a computer system in which a term-search-and-link-creation (TSLC) functionality may be implemented.

FIG. 2 is a block/flow diagram illustrating the architecture, operation, and/or functionality of one embodiment of the TSLC functionality of FIG. 1.

FIG. 3 is a flow chart illustrating the architecture, operation, and/or functionality of another embodiment of the TSLC functionality of FIGS. 1 and 2.

FIG. 4 is a screen shot of one embodiment of a graphical user interface for implementing aspects of the TSLC functionality of FIGS. 1-3.

FIG. 5 illustrates the screen shot of FIG. 4 in which a user selects term(s) to be searched.

FIG. 6 illustrates the screen shot of FIG. 5 with a search initiation window for enabling the user to initiate a search of the selected terms.

FIG. 7 illustrates the screen shot of FIG. 7 with a search options window for enabling the user to select various search parameters.

FIG. 8 illustrates the screen shot of FIG. 7 in which the user selects the web search option.

FIG. 9 illustrates the screen shot of FIG. 8 with a search window displaying the results of the search.

FIG. 10 illustrates the screen shot of FIG. 9 in which the user selects the link entitled “Classical Music.”

FIG. 11 illustrates the screen shot of FIG. 10 in which the user selects the “create link” button to create a hypertext link between the selected terms and the “Classical Music” resource.

FIG. 12 illustrates the screen shot of FIG. 11 after the hypertext link is created within the displayed text.

FIG. 13 illustrates the screen shot of FIG. 12 after the hypertext link is selected by the end user.

### DETAILED DESCRIPTION

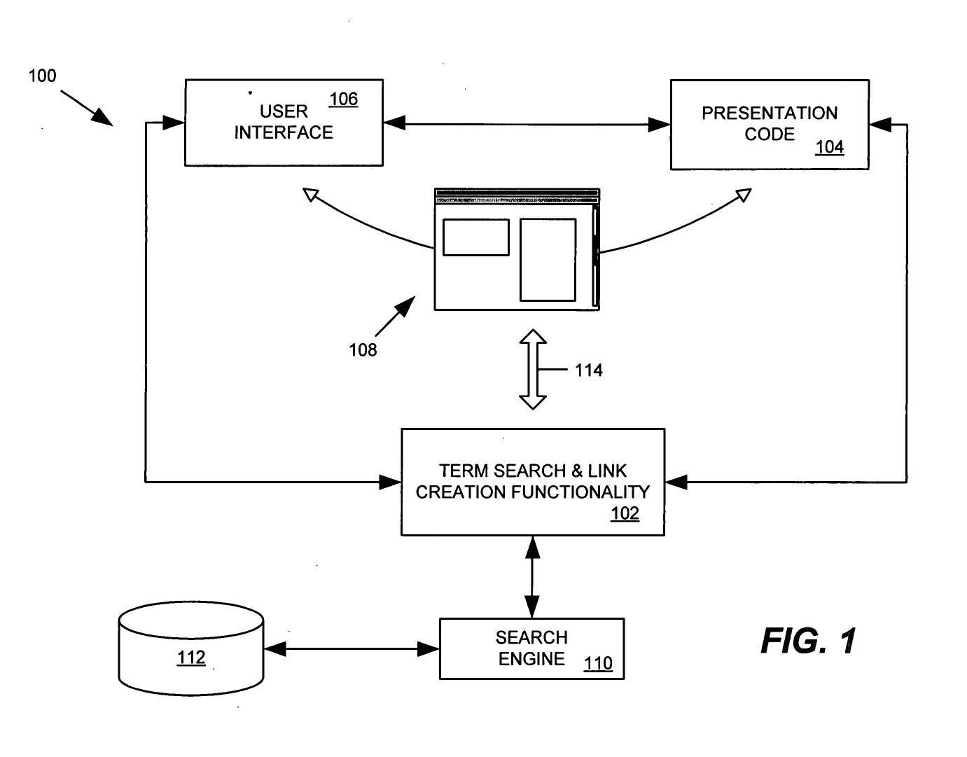

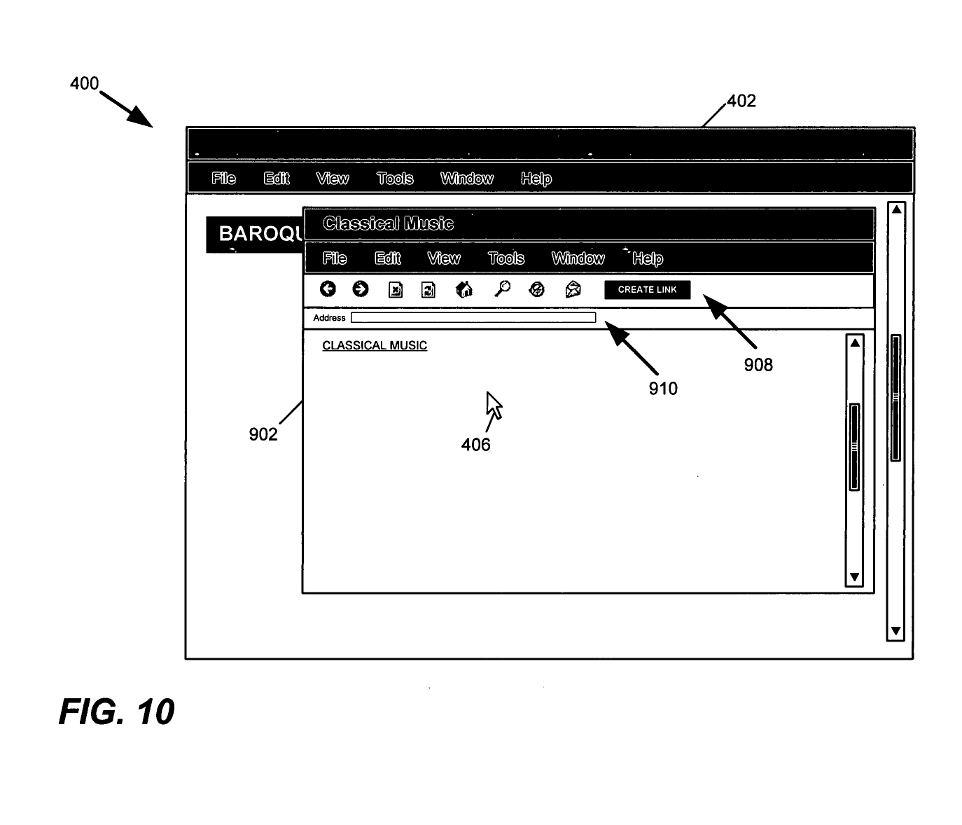

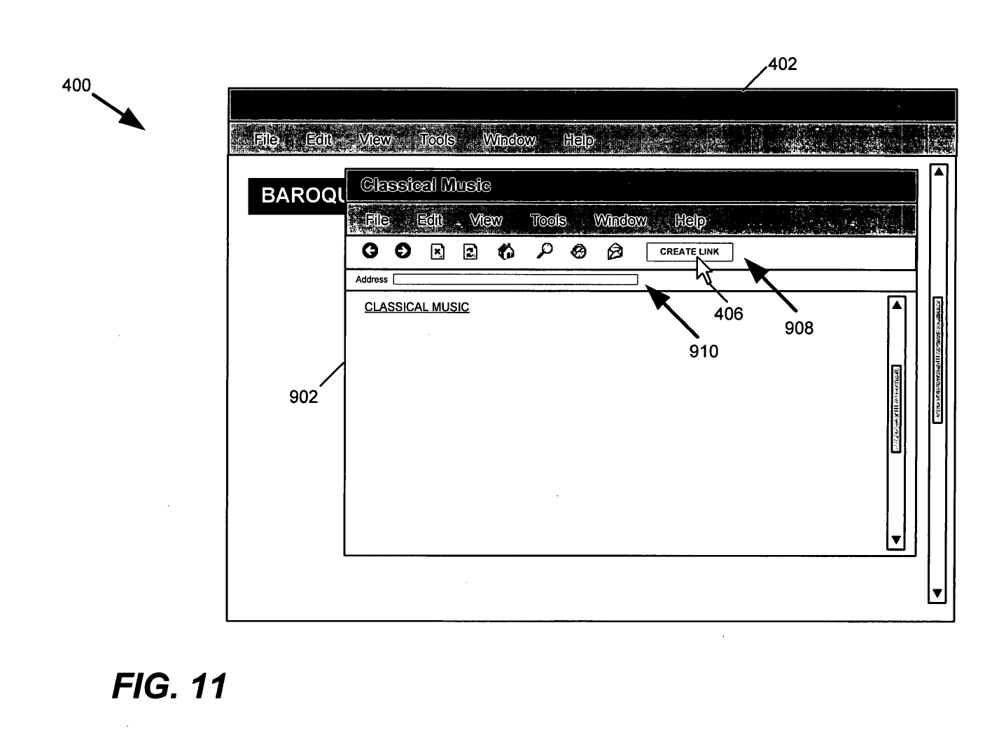

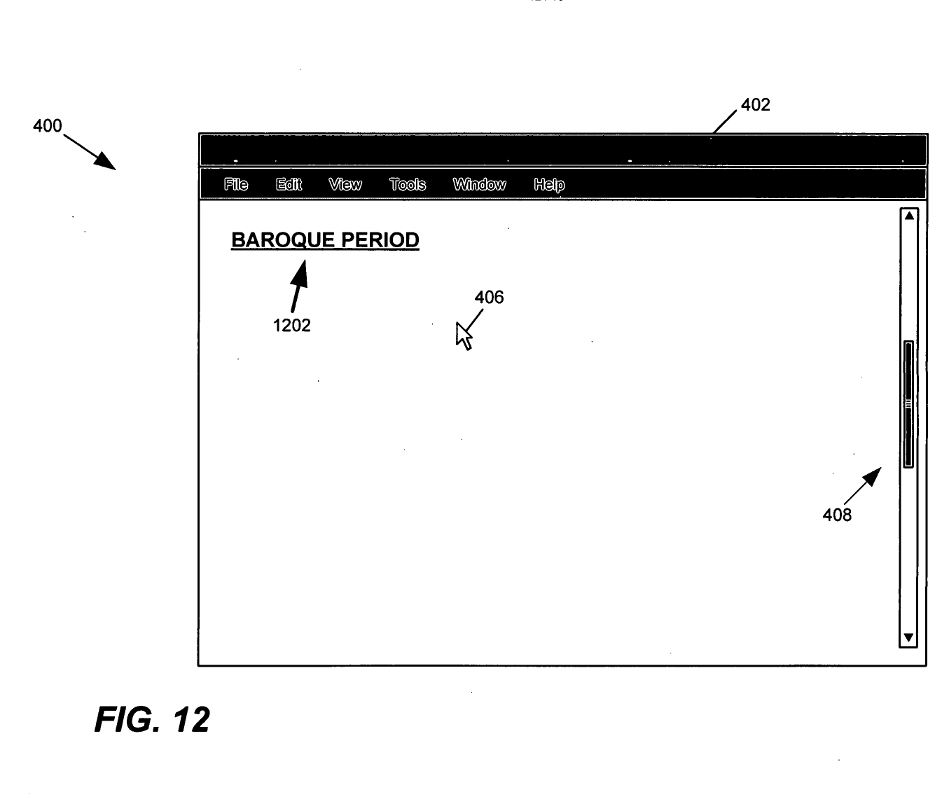

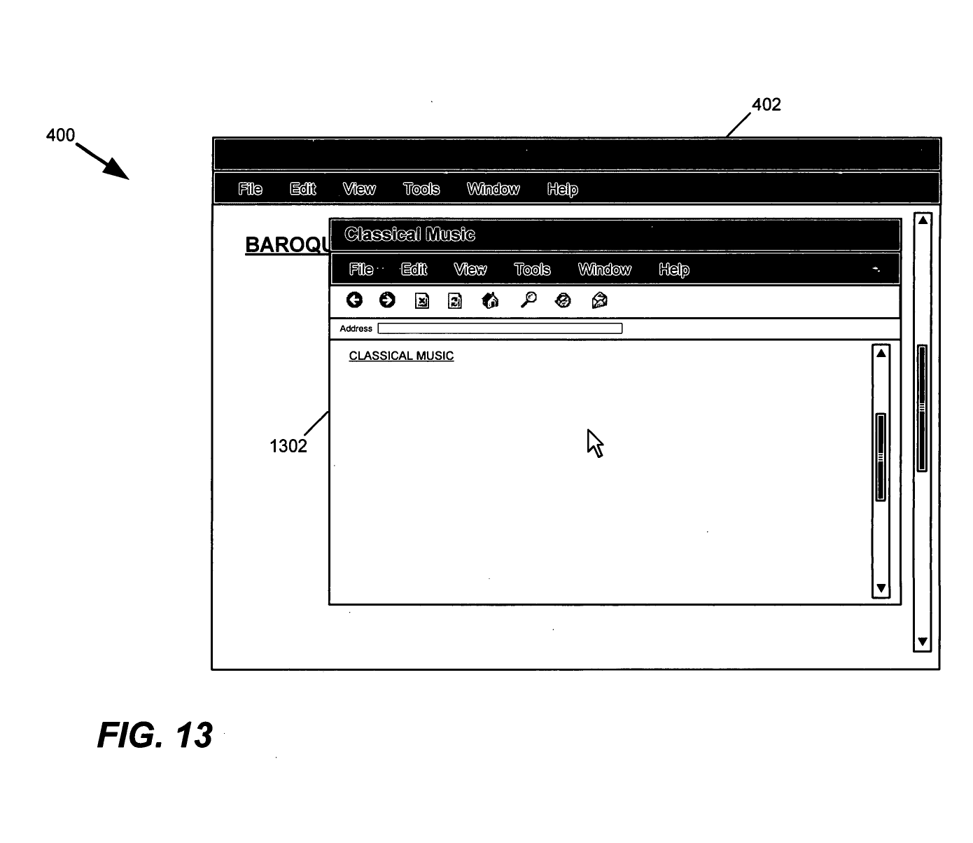

This disclosure relates to various embodiments of computer systems, methods, and associated computer software for enabling a user to conveniently initiate a search of term(s) displayed by presentation code in a graphical user interface (GUI), and to create a link between the term(s) and resource(s) identified in the search. Various embodiments will be described below with reference to FIGS. 1-13.

FIG. 1 illustrates one of a number of embodiments of a computer system 100 comprising a term-search-and-link (TSLC) functionality 102. In general, TSLC functionality 102 comprises logic configured to provide certain advantageous feature(s) to an end user of computer system 100. As illustrated in FIG. 1, computer system 100 comprises presentation code 104 which displays information to the end user via a graphical user interface (GUI) 106. It should be appreciated that presentation code 104 may comprise any suitable computer code for the purpose of displaying information (e.g., text, images, audio, video, or any multimedia) to the end user via GUI 106. Presentation code 104 and GUI 106 may present the information to the end user in a presentation window or screen 108 via any suitable display device.

Presentation code 104 may comprise any suitable computer code, process, program, or application. Presentation code 104 may be implemented in any desirable computer and/or network architecture. For example, presentation code 104 may be implemented as a stand-alone computer application, plug-in or add-on code for an application or otherwise integrated with a computer program, web-based code, etc. Furthermore, it should be understood that, from the perspective of the end user, presentation code 104, GUI 106, and/or any associated code may be integrated with computer code configured to provide any user functions (e.g., word processing, Web browsing, e-mail, document viewing, notepad functionality, or any other function that includes viewing, creating, and/or editing information).

Referring again to FIG. 1, TSLC functionality 102 provides an interface 114 between presentation code 104 and/or GUI 106 and a search facility, such as search engine 110 and associated database 112. The search facility may be local, remote, distributed, or otherwise integrated (or in communication) with TSLC functionality 102. In one embodiment, TSLC functionality 102 interfaces with a web-based search engine, although alternative embodiments may employ any search algorithm or look-up process and an accompanying data resource or database. In another embodiment, the search facility comprises a hypertext system. Regardless the configuration of the particular search facility, TSLC functionality 102 comprises logic configured to enable the computer end user to conveniently initiate a search of term(s) displayed in presentation screen 108 and to create a link in presentation screen 108 between the term(s) and resource(s) identified in the search.

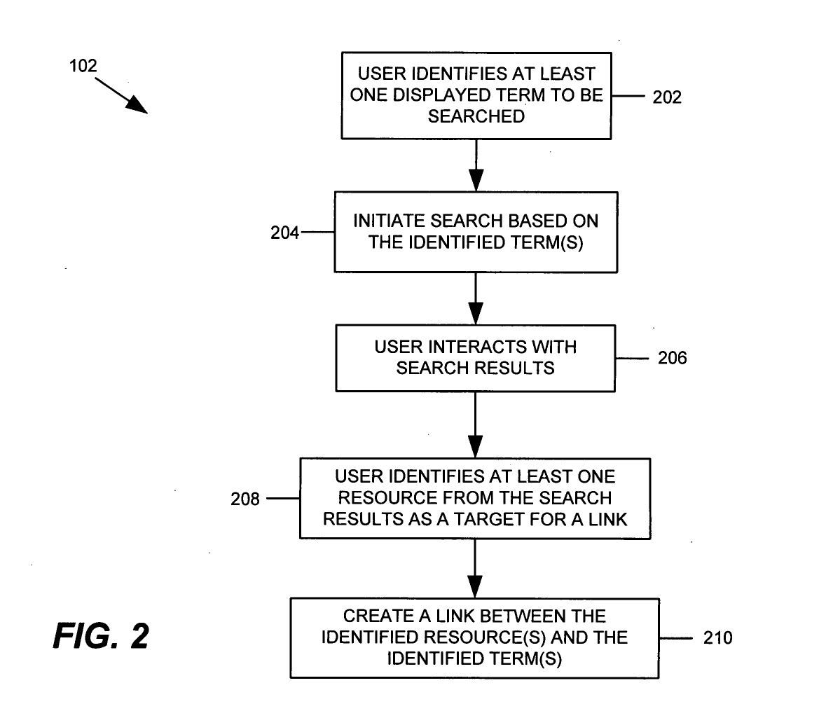

FIG. 2 illustrates the architecture, operation, and/or functionality of one of a number of embodiments of TSLC functionality 102—from the perspective of the computer end user interacting with presentation code 104 and/or GUI 106 through presentation screen 108. At block 202, the computer end user identifies at least one term displayed in presentation screen 108 to be searched. For example, while viewing information displayed in presentation screen 108, the computer end user may desire to research a particular displayed term. The computer end user may select the term(s) and, at block 204, initiate a search of the term(s). The search facility may return the results of the search to TSLC functionality 102 and, at block 206, the computer end user may interact with the search results and identify a particular resource of interest associated with the term(s). For example, the search results may comprise a dictionary look-up of a particular term and the end user may select a desirable definition or synonym to be associated with the term(s) in presentation screen 108. In additional embodiments, the search results may comprise a list of resources provided by a search engine. In this example, the user may interact with the search results (e.g., by selecting certain links, performing additional searches, moving forward and backward in the search results), and then identify a particular resource to which the term(s) are to be linked.

TSLC functionality 102 may provide a UI mechanism for identifying or otherwise selecting the target resource(s) from the search results and, at block 210, a link is created between the target resource(s) and the term(s). It should be appreciated that the link may comprise a hypertext link or any other suitable referencing scheme for enabling the computer end user to access the target resource(s) associated with the term(s) displayed in presentation screen 108. Once the link is created, the computer end user may select the term(s) in presentation screen 108 and link to the target resource(s). One of ordinary skill in the art will appreciate that the user interactions described above with respect to blocks 202, 204, 206, 208, and 210 may be performed using any suitable GUI mechanisms, keystrokes, function keys, hotkeys, etc. Furthermore, any of the user interactions may be performed automatically by TSLC functionality 102 based on certain UI interaction(s).

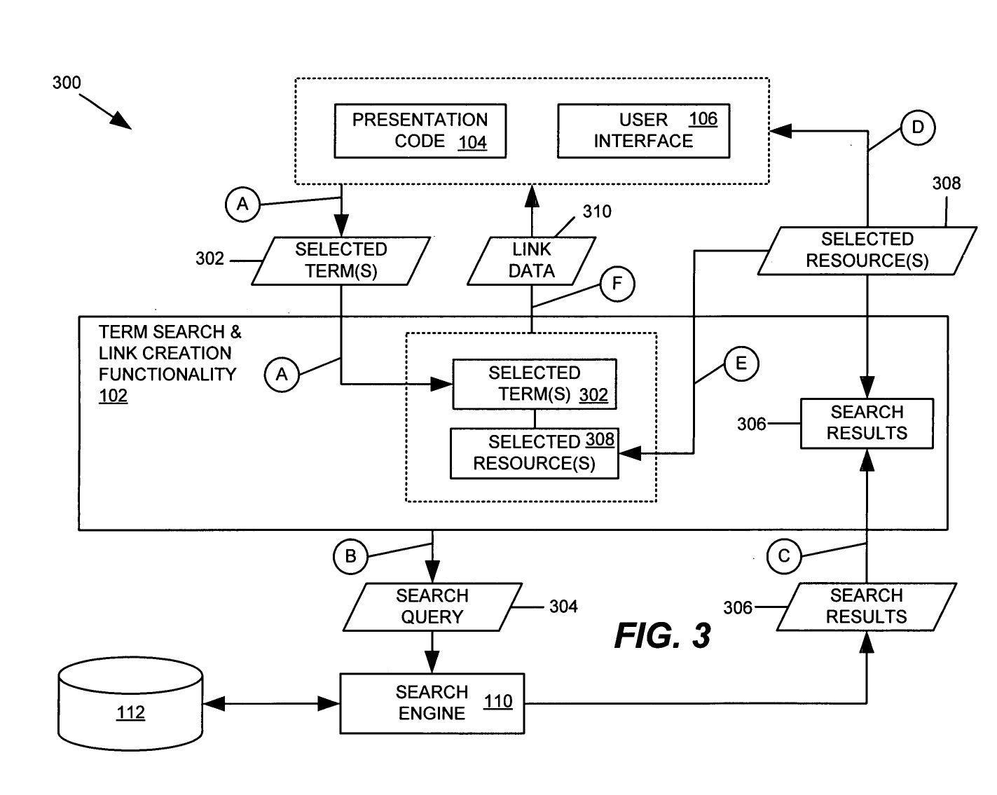

FIG. 3 illustrates a combined block/flow diagram illustrating the architecture, operation, and/or functionality of another embodiment of TSLC functionality 102. TSLC functionality 102 operates as an interface layer between the search facility (e.g., search engine 110) and presentation code 104 and/or GUI 106. At process element A, TSLC functionality 102 receives data representing the term(s) displayed in the presentation screen 108 and which are identified by the computer end user to be searched (selected term(s) 302). Selected term(s) 302 represent the term(s) to be searched by search engine 110. TSLC functionality 102 generates a search query 304 based on selected term(s) 302. Search query 304 may comprise selected term(s) 302 together with any additional criteria, Boolean operators, etc. At process element B, TSLC functionality 102 provides search query 304 to search engine 110. Search engine 110 may employ any suitable search algorithm to determine whether database 112 includes any relevant documents, resources, or other objects corresponding to search query 304.

At process element C, TSLC functionality 102 receives search results 306 which correspond to search query 304. Search results 306 may be provided to the computer end user via presentation code 104 and/or GUI 106. It should be understood that search results 306 may be presented in any desirable form. In one embodiment, search results 306 are displayed in a separate window or screen. As illustrated by process element D, the computer end user may interact with search results 306 via GUI 106 by, for example, selecting various resources, documents, web pages, files, etc. In another embodiment, the computer end user browses search results 306 using a browser-type application or computer code. Regardless the presentation scheme, the computer end user may interact with search results 308. If a suitable resource is discovered in search results 308 (or additional searches), the computer end user may desire to associate selected term(s) 302 displayed in presentation screen with the target resource(s). At process element E, TSLC functionality 102 may receive selected resource(s) 308, which represent link target(s). TSLC functionality 102 associates selected resource(s) 308 with selected term(s) 302, and passes appropriate data for generating a link to selected resource(s) 308 (e.g., link data 310) to presentation code 104. Presentation code 104 uses link data 310 to generate a link within presentation screen 108 between the displayed term(s) and selected resource(s) 308.

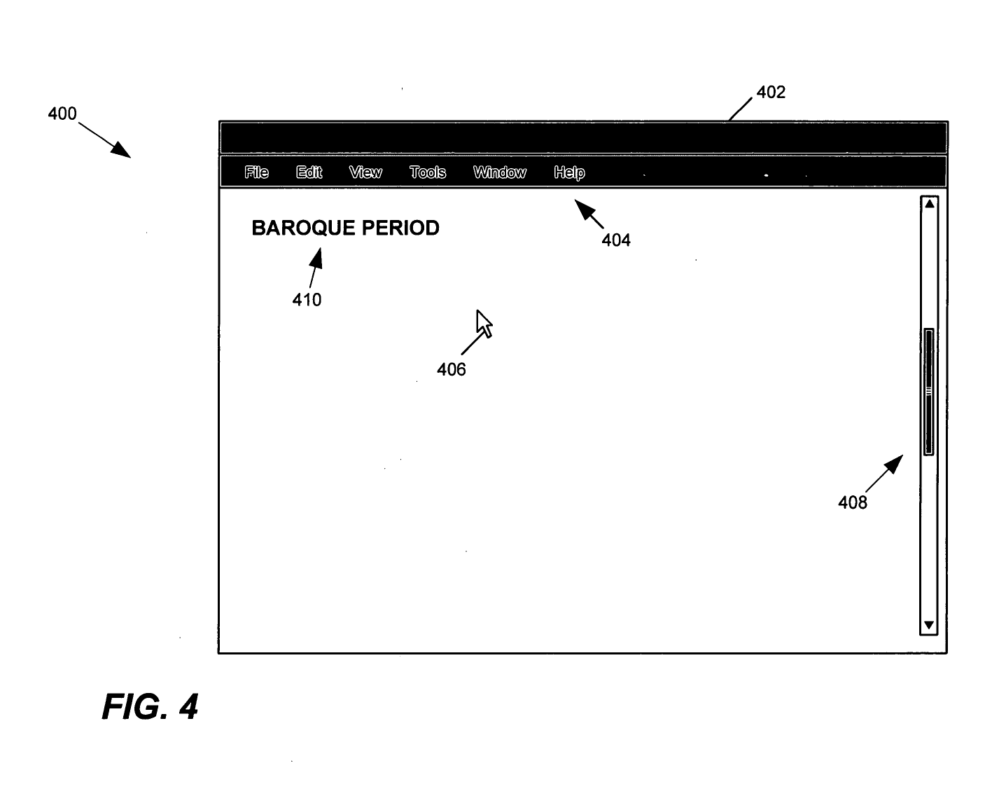

A further embodiment of TSLC functionality 102 is described below with respect to the user interface screen shots of FIGS. 4-13. It should be appreciated that the screen shots illustrate but one of a number of possible embodiments of a user interface. The user interface displays a presentation window 402 from which a computer end user may access the term-search-and-link-creation feature described above. As illustrated in FIG. 4, presentation window 402 comprises various GUI elements, such as a menu bar 404, a mouse pointer 406, and a vertical scroll bar 408. It should be appreciated that additional, or fewer, GUI elements may be included, as desirable, based on the particular functionality of presentation code 104 and/or GUI 106.

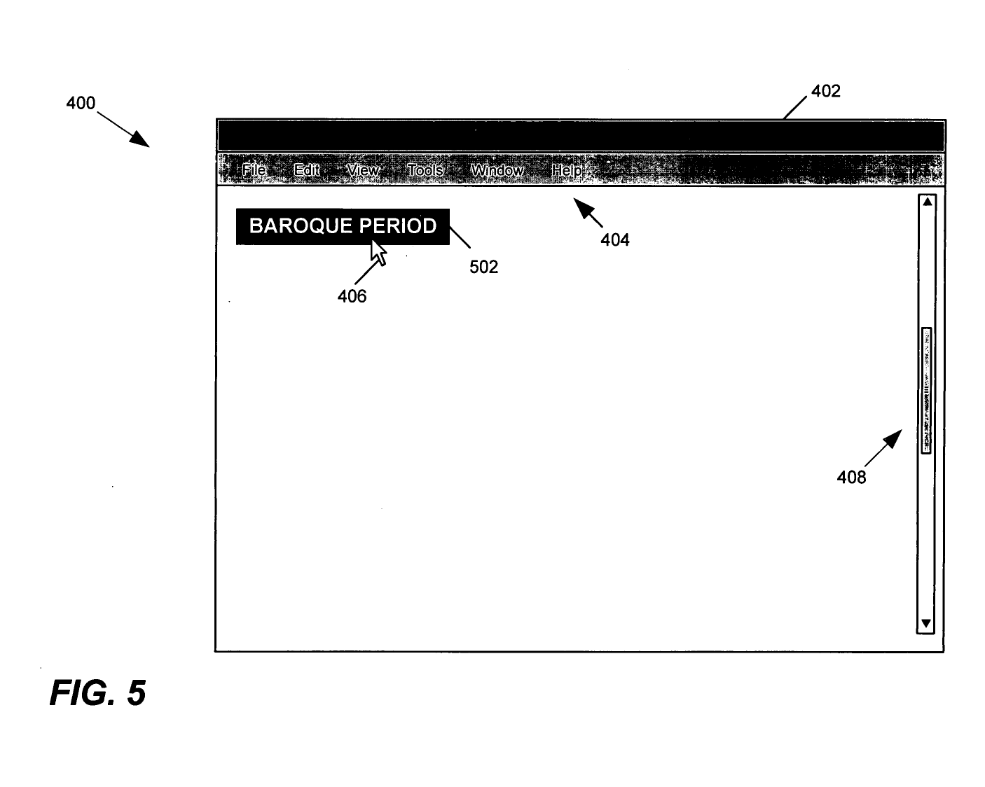

The relevant aspect is that presentation window 402 displays one or more terms 410 (e.g., “BAROQUE PERIOD”). It should be appreciated that term(s) 410 may be presented in any desirable format, including, but not limited to, text, images, and the like. While viewing the content provided in presentation window 402, the computer end user may desire to perform a search of certain term(s) 410. As illustrated in FIG. 5, the computer end user may employ cursor 406 to select term(s) 410. The computer end user may select term(s) 410 in any suitable fashion using the particular functionality provided by GUI 106. For example, in embodiments where term(s) 410 comprise text, the end user may insert a cursor at or near term(s) 410 and engage any number of suitable “select” commands. The computer end user may also perform a mouse over and right-click (or similar) operation to select term(s) 410. If term(s) 410 are presented as images, rather than text, the computer end user may select the object representing the terms, and an optical character recognition (OCR) functionality may automatically determine the corresponding term(s).

The search may be initiated in a number of ways. In a simplistic approach, the search may be initiated by a simple keystroke, or the like, after term(s) 410 are selected by the end user. For example, in FIG. 5, the term(s) 502 are visually distinguished as highlighted text.

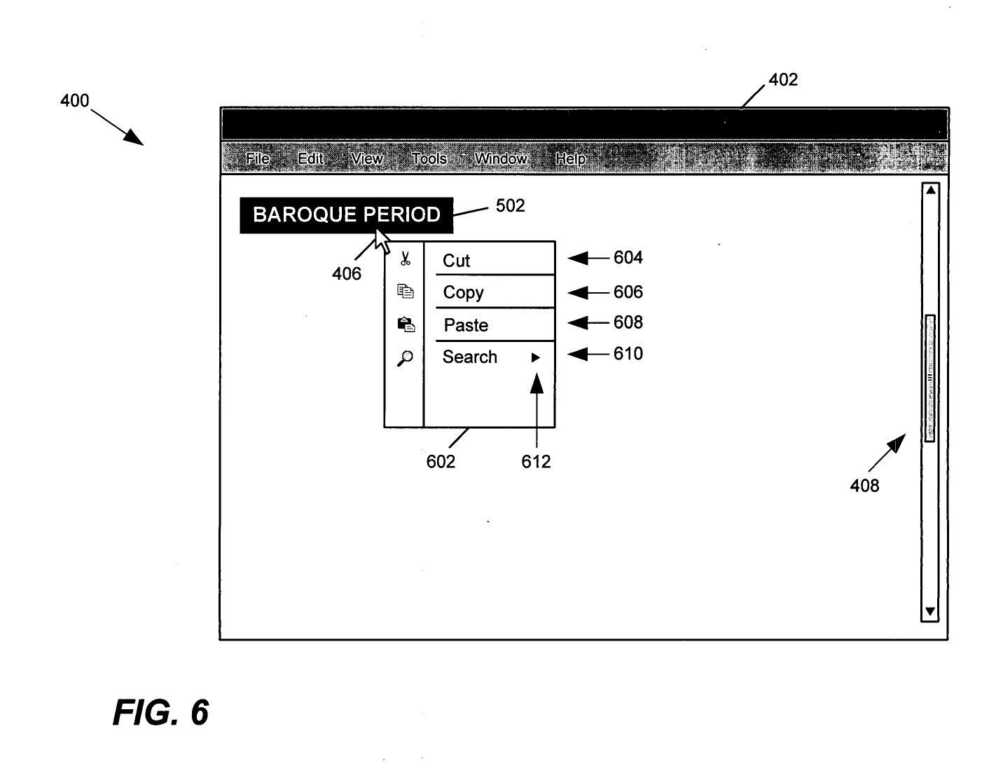

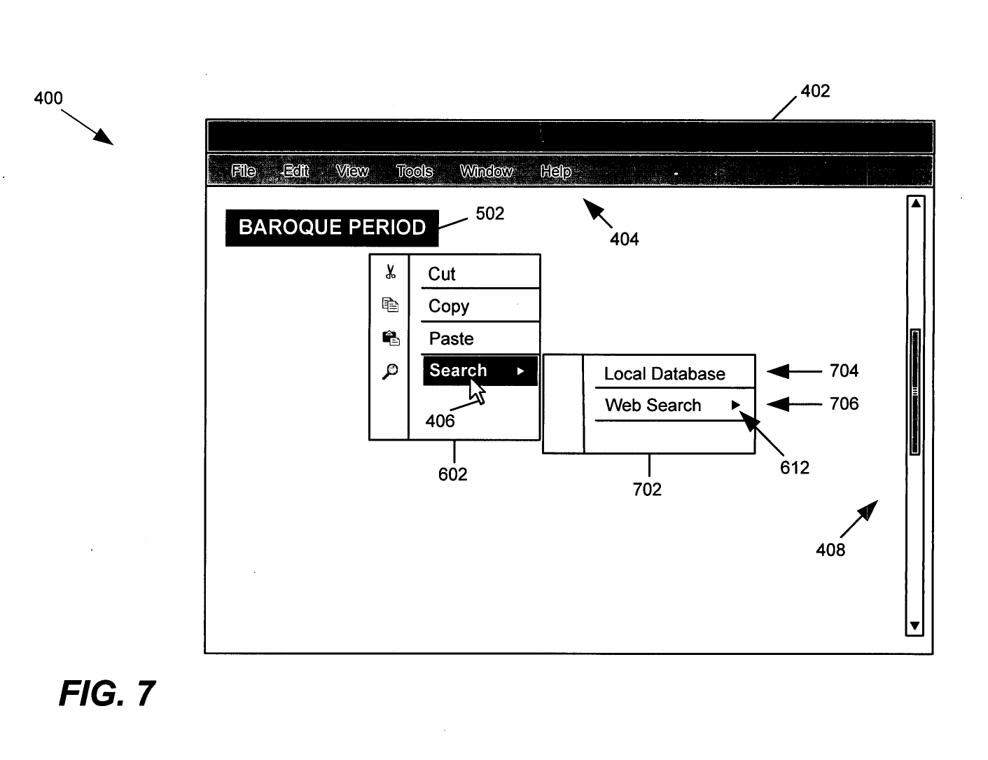

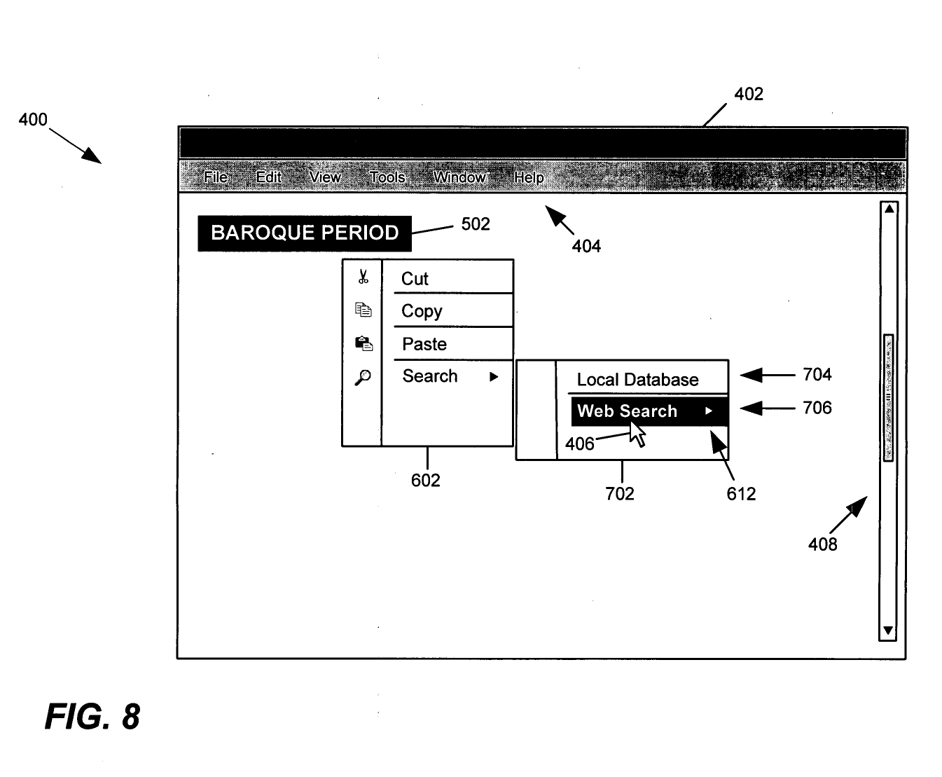

In the embodiment illustrated in FIGS. 6-8, the search may be initiated via a menu (or a series of layered menus). After selecting term(s) 502, the computer user may trigger a menu 602 by any suitable command (e.g., a right-mouse-click command while pointer 406 is in proximity of selected term(s) 502). Menu 602 comprises various rows of menu options, such as “Cut” option 604, “Copy” option 606, “Paste” option 608, and “Search” option 610. As illustrated in FIGS. 7 and 8, Search option 610 may include a sub-menu 702 which enables the computer end user to specify various search-related parameters. For instance, sub-menu 702 may include a “Local Database” option 704 (for initiating a local search) and a “Web Search” option 706 (for specifying a particular type of search facility.

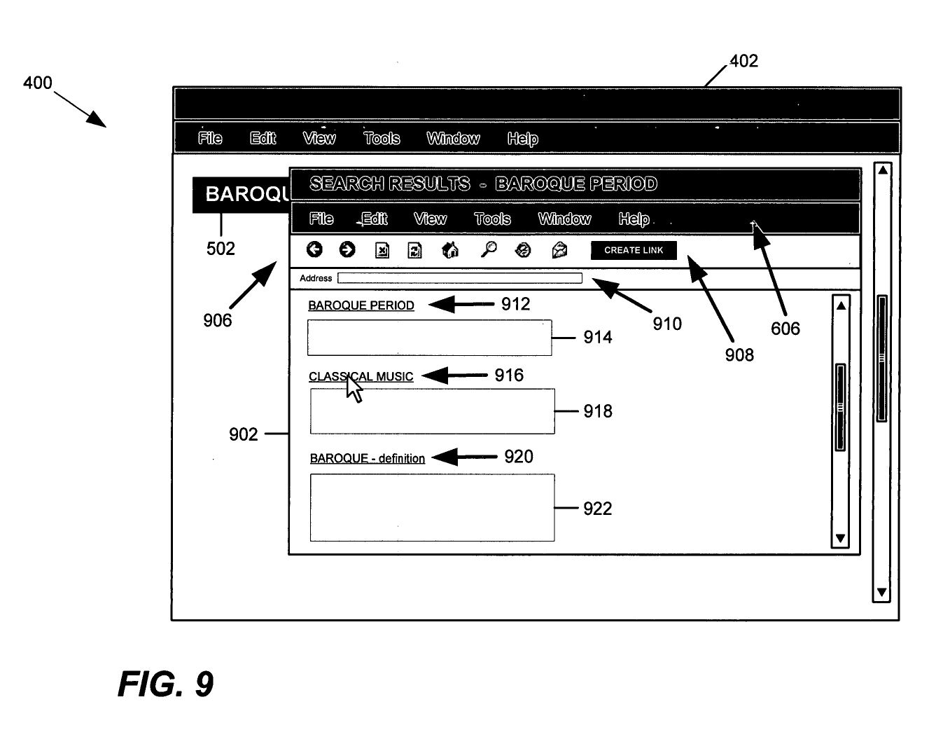

After the search is performed, the search results may be displayed in a search results window 902 (FIG. 9). As mentioned above, the search results may be displayed in any suitable matter. In the embodiment illustrated in FIG. 9, search results window 902 comprises a browser-type window in which the resources are provided as a list of hypertext links (e.g., objects 912, 916, and 920) and associated text descriptions of the resources (e.g., objects 914, 918, and 922). The computer end user may view the resources by selecting the hypertext links. If the user discovers a useful resource, a link may be created by selecting a create link button 908. When create link button 908 (or any UI command) is engaged, TSLC functionality 102 generates a link between term(s) 410 and the selected resource.

One of ordinary skill in the art will appreciate that TSLC functionality 102 may be implemented in software, hardware, firmware, or a combination thereof. Accordingly, in one embodiment, TSLC functionality 102 is implemented in software or firmware that is stored in a memory and that is executed by a suitable instruction execution system. In software embodiments, TSLC functionality 102 may be written any computer language.

It should be appreciated that the process descriptions or blocks related to FIGS. 1-13 represent modules, segments, or portions of code which include one or more executable instructions for implementing specific logical functions or steps in a process. It should be further appreciated that any logical functions may be executed out of order from that shown or discussed, including substantially concurrently or in reverse order, depending on the functionality involved, as would be understood by those reasonably skilled in the art.

Furthermore, TSLC functionality 102 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A computer system comprising:
a graphical user interface;
presentation code for displaying information via the graphical user interface;
a search engine; and
term-search-and-link-creation (TSLC) code comprising logic configured to enable a user to select a term displayed by the presentation code, initiate a search of the term via the search engine, and create a hypertext link between the term and a resource from results of the search.

2. The computer system of claim 1, wherein the presentation code comprises one of a browser, an application, and a web service.

3. The computer system of claim 1, wherein the search engine comprises one of a local search engine and a web-based search engine.

4. A computer system comprising:
presentation code for displaying information via a graphical user interface; and
a term-search-and-link-creation (TSLC) module for interfacing with the presentation code and a search engine, the TSLC module comprising:
logic configured to receive a user term selection of at least one term displayed by the presentation code;
logic configured to initiate a search with the search engine based on the at least one displayed term;
logic configured to receive a user resource selection of at least one resource from results of the search; and
logic configured to generate a link between the at least one displayed term and the at least one resource.

5. The computer system of claim 4, wherein the presentation code comprises one of a browser, an application, and a web service.

6. The computer system of claim 4, wherein the presentation code comprises a notepad application.

7. The computer system of claim 4, wherein the TSLC module is configured to interface with a local search engine.

8. The computer system of claim 4, wherein TSLC module is configured to interface with a web-based search.

9. The computer system of claim 4, wherein the TSLC module is configured to initiate the search by sending a search query to the search engine, the search query comprising the at least one term.

10. The computer system of claim 9, wherein the TSLC module is configured to enable a user to interact with the search results from the search engine via the graphical user interface.

11. The computer system of claim 4, wherein the TSLC module is configured to create the hypertext link by linking the at least one term to the at least one resource and passing link data to the presentation code.

12. A computer program, embodied in a computer-readable medium and executable by a processor, the computer program comprising:
logic configured to enable a user to select a term displayed by presentation code in a graphical user interface environment;
logic configured to initiate a search of the term; and
logic configured to generate a hypertext link between the term and a resource from results of the search.

13. The computer program of claim 12, wherein the logic configured to initiate the search comprises logic configured to enable the user to select at least one of a plurality of search engines.

14. The computer program of claim 13, wherein the logic configured to initiate the search comprises logic configured to enable the user to specify a search parameter.

15. A method for performing a computer-based search within a presentation window of a graphical user interface, the method comprising:
selecting an object displayed by presentation code in a graphical user interface, the selected object corresponding to at least one term to be searched;
initiating a search of the at least one term;
displaying the results of the search;
selecting a resource from the results to be linked to the selected object; and
linking the selected object displayed by the presentation code to the selected resource.

16. The method of claim 15, wherein the linking the selected object to the selected resource comprises passing link data to the presentation code.

17. The method of claim 15, wherein the linking the selected object to the selected resource comprises generating a hypertext link between the selected object and the selected resource.

18. The method of claim 15, wherein the selected object comprises text.

19. The method of claim 18, wherein the selecting the object comprises highlighting the text.

20. The method of claim 15, wherein the initiating the search comprises sending a query to a search engine.
